(19) United States
(12) Patent Application Publication
(10) Pub. No.: US 2026/0286858 A1
(43) Pub. Date: Sep. 24, 2026

(54) Operational Modes of Direct Drive Clearance Control System

(71) Applicant: RTX Corporation, Farmington, CT (US)

(72) Inventors: Andre M. AJAMI, Henderson, NV (US); Coy B. WOOD, Ellington, CT (US); Michael G. MCCAFFREY, Windsor, CT (US); John R. FARRIS, Lebanon, CT (US)

(21) Appl. No.: 19/085,957

(22) Filed: Mar. 20, 2025

(51) Int. Cl. F01D 11/20; F01D 21/00

(52) U.S. Cl. CPC F01D 11/20; F01D 21/003

(57) ABSTRACT

A method for controlling clearance between a blade outer air seal (BOAS) and a rotating portion of a gas turbine engine comprising detecting an operating mode of the gas turbine engine, monitoring a current clearance between the BOAS and the rotating portion of the gas turbine engine and adjusting a position of the BOAS to alter the clearance from the current clearance to a baseline clearance associated with the detected operating mode.

### TECHNICAL FIELD

This disclosure relates generally to control of blade outer air seals in a gas turbine engine. More specifically, this disclosure relates to various control modes for blade outer air seals based on gas turbine engine operating state.

### BACKGROUND

Turbine clearance control systems are currently performed using open-loop schedules based on expected thermal response of turbine materials. This direct measurement of clearance enables direct measurement and allows for rapid, robust measurement and a closed-loop control system that actively controls clearance based on any condition. However, the sensors used for detecting the distances between components are often required to operate within highly challenging operating environments that can cause degradation of the sensors. The sensed clearances between gas turbine engine components must then be used to vary the clearances based on current gas turbine engine operating mode.

### SUMMARY

This disclosure relates to operating modes for blade outer air seals in a gas turbine engine.

In some examples, a method for controlling clearance between a blade outer air seal (BOAS) and a rotating portion of a gas turbine engine includes detecting an operating mode of the gas turbine engine, monitoring a current clearance between the BOAS and the rotating portion of the gas turbine engine and adjusting a position of the BOAS to alter the clearance from the current clearance to a baseline clearance associated with the detected operating mode.

Any single one or any combination of the following features may be used with the examples above. The method may include establishing the baseline clearance between the BOAS and the rotating portion of the gas turbine engine during a cold calibration mode of the gas turbine engine during gas turbine engine manufacture, calculating a minimum clearance, a maximum clearance and an average clearance between the BOAS and the rotating portion of the gas turbine engine during the cold calibration mode responsive to the established baseline clearance and storing the baseline clearance, the minimum clearance, the maximum clearance and the average clearance. Adjusting the position of the BOAS further may include: determining if the rotating portion of the gas turbine engine is equalized with the BOAS, decreasing the current clearance between the BOAS and the rotating portion of the gas turbine engine responsive to a determination that the rotating portion of the gas turbine engine is not equalized with the BOAS and storing the current clearance as the baseline clearance responsive to the determination that the rotating portion of the gas turbine engine is equalized with the BOAS. Adjusting the position of the BOAS further may include detecting an acceleration of the gas turbine engine, detecting a decrease in the current clearance between the BOAS and the rotating portion of the gas turbine engine responsive to the detected acceleration and retracting the BOAS to increase the current clearance responsive to the detected decrease of the current clearance. Adjusting the position of the BOAS further may include detecting a deceleration of the gas turbine engine, detecting an increase in the current clearance between the BOAS and the rotating portion of the gas turbine engine responsive to the detected deceleration, and moving the BOAS to decrease the current clearance responsive to the detected increase of the current clearance. Adjusting the position of the BOAS further may include determining a speed of the gas turbine engine has stabilized and moving the BOAS to the baseline clearance responsive to the determination that the speed of the gas turbine engine has stabilized. Adjusting the position of the BOAS further may include determining occurrence of a hot reburst condition within the gas turbine engine and moving the BOAS to alter the current clearance responsive to detection of the hot reburst condition. Adjusting the position of the BOAS further may include detecting g-loads and angular rotation induced loads acting upon the gas turbine engine, determining the BOAS effected by the detected g-loads and angular rotation induced loads and adjusting a position of the BOAS effected by the detected g-loads and angular rotation induced loads to counteract the detected g-loads and angular rotation induced loads. Adjusting the position of the BOAS further may include determining a change in the current clearance caused by long term deterioration factors and adjusting a position of the BOAS to overcome the long term deterioration factors.

In other examples, a system for controlling clearance within a gas turbine engine includes a rotating portion of the gas turbine engine, a blade outer air seal (BOAS) configured to move between a plurality of positions with respect to the rotating portion of the gas turbine engine, a controller configured to control movement of the BOAS between the plurality of positions with respect to the rotating portion of the gas turbine engine, where the controller is further configured to: detect an operating mode of the gas turbine engine, monitor a current clearance between the BOAS and the rotating portion of the gas turbine engine and adjust a position of the BOAS to alter the clearance from the current clearance to a baseline clearance associated with the detected operating mode.

Any single one or any combination of the following features may be used with the examples above. The system where the controller is further configured to establish the baseline clearance between the BOAS and the rotating portion of the gas turbine engine during a cold calibration mode of the gas turbine engine during gas turbine engine manufacture, calculate a minimum clearance, a maximum clearance and an average clearance between the BOAS and the rotating portion of the gas turbine engine during the cold calibration mode responsive to the established baseline clearance and store the baseline clearance, the minimum clearance, the maximum clearance and the average clearance. The controller is further configured to: determine if the rotating portion of the gas turbine engine is equalized with the BOAS, decrease the current clearance between the BOAS and the rotating portion of the gas turbine engine responsive to a determination that the rotating portion of the gas turbine engine is not equalized with the BOAS and store the current clearance as the baseline clearance responsive to the determination that the rotating portion of the gas turbine engine is equalized with the BOAS. The controller is further configured to: detect an acceleration of the gas turbine engine, detect a decrease in the current clearance between the BOAS and the rotating portion of the gas turbine engine responsive to the detected acceleration and retract the BOAS to increase the current clearance responsive to the detected decrease of the current clearance. The controller is further configured to: detect a deceleration of the gas turbine engine, detect an increase in the current clearance between the BOAS and the rotating portion of the gas turbine engine responsive to the detected deceleration and move the BOAS to decrease the current clearance responsive to the detected increase of the current clearance. The controller is further configured to: determine a speed of the gas turbine engine has stabilized and move the BOAS to the baseline clearance responsive to the determination that the speed of the gas turbine engine has stabilized. The controller is further configured to: determine occurrence of a hot reburst condition within the gas turbine engine and move the BOAS to alter the current clearance responsive to detection of the hot reburst condition. The controller is further configured to: detect g-loads and angular rotation induced loads acting upon the gas turbine engine, determine the BOAS effected by the detected g-loads and angular rotation induced loads and adjust a position of the BOAS effected by the detected g-loads and angular rotation induced loads to counteract the detected g-loads and angular rotation induced loads. The controller is further configured to: determine a change in the current clearance caused by long term deterioration factors and adjust a position of the BOAS to overcome the long term deterioration factors.

In still other examples, a method for controlling clearance between a blade outer air seal (BOAS) and a rotating portion of a gas turbine engine includes detecting an operating mode of the gas turbine engine, where the operating mode may include one of an acceleration mode, a deceleration mode, a hot reburst mode, a high-g maneuver mode, monitoring a current clearance between the BOAS and the rotating portion of the gas turbine engine responsive to the detected operating mode of the gas turbine engine, and adjusting a position of the BOAS to maintain the current clearance at a predetermined level associated with the detected operating mode.

Any single one or any combination of the following features may be used with the examples above. The method may include establishing the predetermined level associated with the detected operating mode during calibration of the gas turbine engine.

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates a partial cross-sectional view of a gas turbine engine, in accordance with various embodiments;

FIG. 2 illustrates a partial cross-sectional view of a rotor assembly, in accordance with various embodiments;

FIG. 3 illustrates a partial cross-sectional view of an embodiment of a blade outer air seal assembly;

FIG. 4 illustrates a partial cross-sectional view of a blade outer air seal assembly, in accordance with various embodiments;

FIG. 5 illustrates a block diagram of the interconnection of a waveguide and blade outer air seals using a controller;

FIG. 6 illustrates a microwave sensor installed with respect to blade outer air seals;

FIG. 7 illustrates a single microwave sensor installed with respect to multiple blade outer air seals installed on a diffuser case;

FIG. 8 illustrates the movement of a blade outer air seal with respect to a microwave sensor;

FIG. 9 illustrates the operation of a microwave sensor with respect to a target such as a blade tip of a turbine;

FIG. 10 illustrates a flow chart of a process for controlling a BOAS to enable cold calibration of the control system during construction of the gas turbine engine;

FIG. 11 illustrates a flow chart for the green run break-in cycle or a post maintenance/inspection/overhaul event for the gas turbine engine;

FIG. 12 illustrates a flow diagram of the process for controlling operation of the BOAS responsive to an acceleration of the gas turbine engine;

FIG. 13 illustrates a flow diagram of the process for controlling operation of the BOAS responsive to a deceleration of the gas turbine engine;

FIG. 14 illustrates a flow diagram of the process for controlling the BOAS responsive to a hot reburst condition of the gas turbine engine;

FIG. 15 illustrates a flow diagram of the process for controlling positioning of the BOAS responsive to high-speed maneuvering of the aircraft containing the gas turbine engine; and

FIG. 16 illustrates a flow diagram for controlling the BOAS to account for turbine blades position and health monitoring during engine operation.

### DETAILED DESCRIPTION

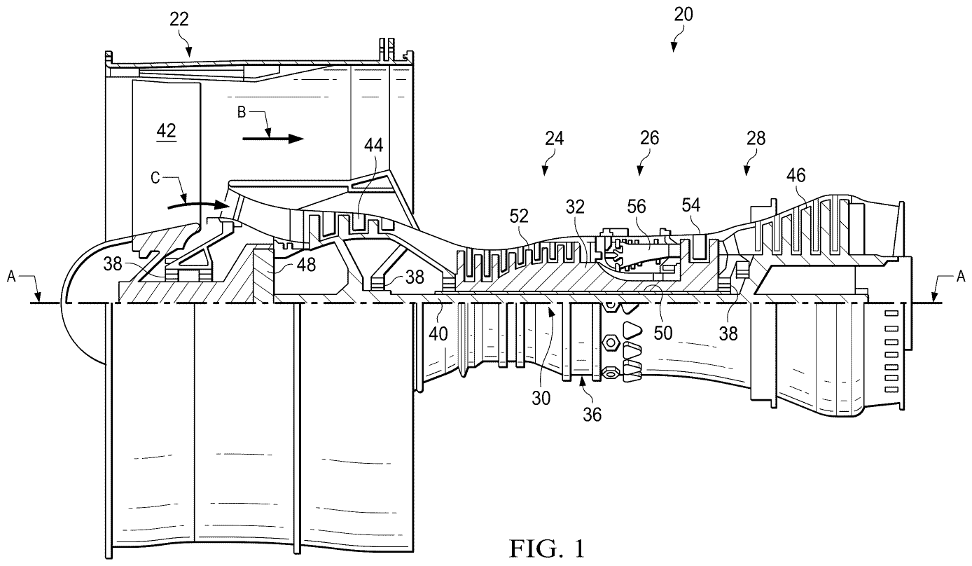

FIGS. 1 through 16, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

Referring now to FIG. 1, a cross-sectional schematic view of a gas turbine engine 20 is illustrated, in accordance with various embodiments. The gas turbine engine 20 is disclosed herein as a two-spool turbofan that generally incorporates a fan section 22, a compressor section 24, a combustor section 26 and a turbine section 28. Alternative engines might include other systems or features. The fan section 22 drives air along a bypass flow path B in a bypass duct, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low-speed spool 30 and a high-speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low-speed spool 30 generally includes an inner shaft 40 that interconnects a fan 42, a low-pressure compressor 44 and a low pressure turbine 46. The inner shaft 40 is connected to the fan 42 through a speed change mechanism, which in exemplary gas turbine engine 20 is illustrated as a gear system 48 to drive the fan 42 at a lower speed than the low-speed spool 30. The high-speed spool 32 includes an outer shaft 50 that interconnects a high-pressure compressor 52 and high-pressure turbine 54. A combustor 56 is arranged in exemplary gas turbine engine 20 between the high-pressure compressor 52 and the high-pressure turbine 54. An engine static structure 36 is arranged generally between the high-pressure turbine 54 and the low-pressure turbine 46. The engine static structure 36 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low-pressure compressor 44 then the high-pressure compressor 52, mixed and burned with fuel in the combustor 56, then expanded over the high-pressure turbine 54 and low-pressure turbine 46. The turbines 46, 54 rotationally drive the respective low speed spool 30 and high-speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high bypass geared aircraft engine. In a further example, the engine 20 bypass ratio is greater than about six (6), with an example embodiment being greater than about ten (10), the gear system 48 is an epicyclic gear train, such as a planetary gear system or other gear system, with a gear reduction ratio of greater than about 2.3 and the low-pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The gear system 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present disclosure is applicable to other gas turbine engines including direct drive turbofans.

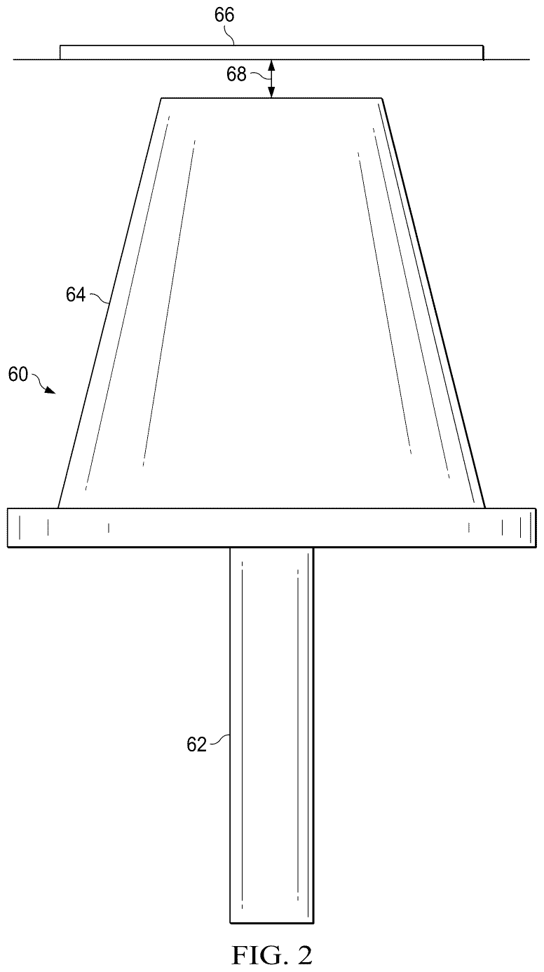

Referring now to FIG. 2, a partial cross-section of a rotor 60, (e.g., a rotor of the high-pressure turbine 54) is illustrated, in accordance with various embodiments. One skilled in the art, however, will appreciate that the present disclosure may be readily applied to other rotors of the gas turbine engine 20, for example, the low-pressure turbine 46, the low-pressure compressor 44, or the high pressure compressor 52. The rotor 60 includes a rotor disc 62 and a plurality of rotor blades 64 extending radially outwardly from the rotor disc 62. The rotor 60 is configured to rotate about the engine central longitudinal axis A. The rotationally stationary structure surrounding the rotor 60 includes a plurality of blade outer air seals (BOAS) 66. The BOAS 66 at least partially defines a blade clearance 68 between the plurality of rotor blades 64 and the BOAS 66.

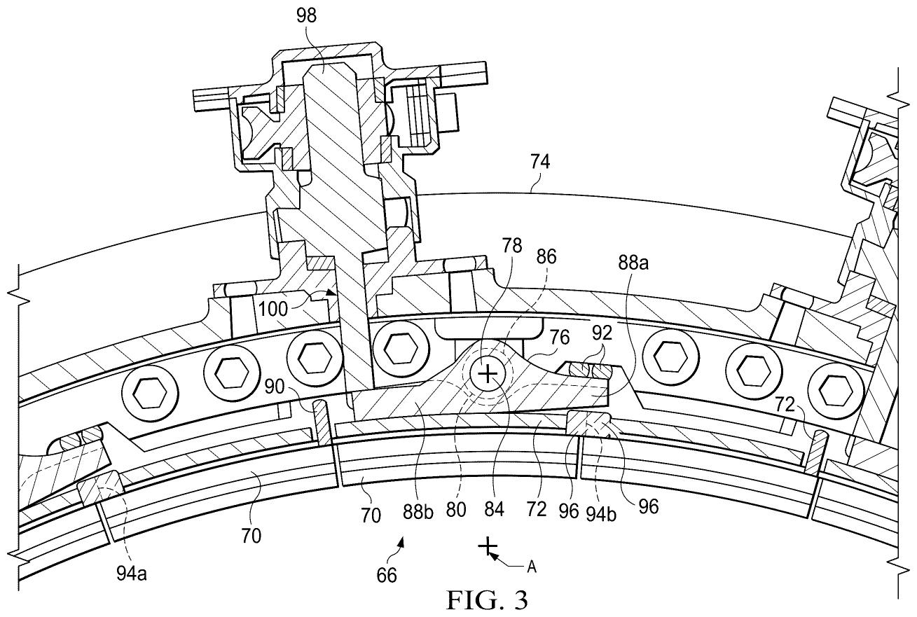

Referring now to FIG. 3, a cross-sectional view of a BOAS 66 configuration is illustrated. The BOAS 66 includes a plurality of BOAS segments 70 arrayed circumferentially around the engine central longitudinal axis A. While the embodiment of FIG. 3 includes 30 BOAS segments 70, that number is merely exemplary and other quantities of BOAS segments 70 may be utilized. The BOAS segments 70 are retained in BOAS carriers 72 located radially outboard of the BOAS segments 70. In some embodiment, such as illustrated, each BOAS carrier 72 has two BOAS segments 70 secured thereto, while in other embodiments each BOAS carrier 72 may carry, for example, one or three BOAS segments 70. The BOAS carriers 72 are movably retained in a case member 74 located radially outboard of the BOAS carriers 72, so that the BOAS carriers 72 and thus the BOAS segments 70 are movable in a radial direction.

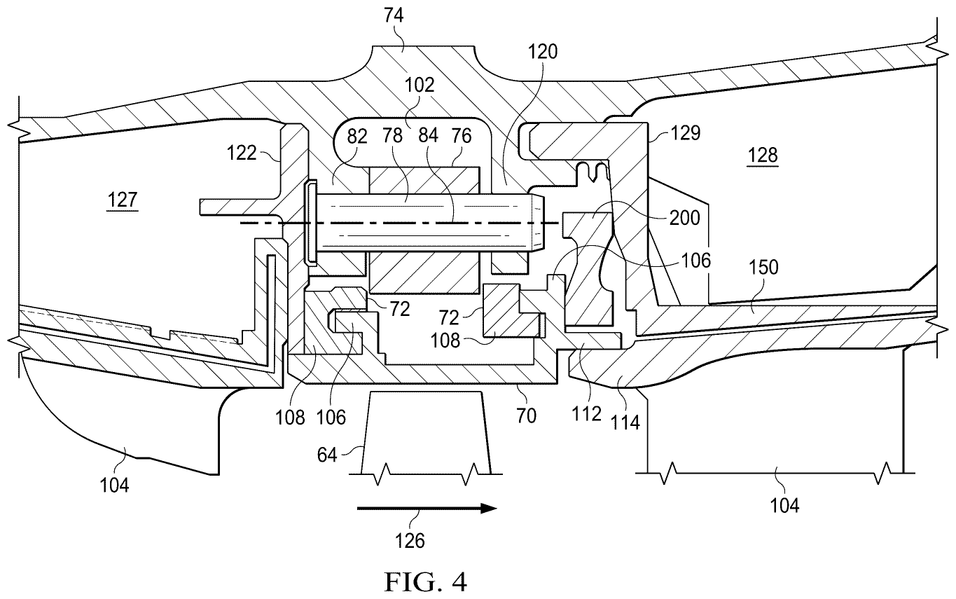

To effect movement of the BOAS segments 70, the BOAS carriers 72 are operably connected to a plurality of adjustment levers 76 secured to the case member 74. The adjustment levers 76 are each retained at the case member 74 via a pin 78 extending through a lever pivot 80 and a casing flange 82, best shown in FIG. 4. The pin 78 defines a lever axis 84 about which the adjustment lever 76 is rotatable. The pin 78, in this example, has a shoulder which engages a recess in casing flange 82 coupled with the cover plate 122, which both, combined, prevent relative motion of the pin 78 along lever axis 84. Referring again now to FIG. 3, the adjustment lever 76 has a hub portion 86 through which the pin 78 extends and two lever arms 88 extending opposite circumferential directions from the hub portion 86. The BOAS carriers 72 each have a carrier body 90 which supports the BOAS segments 70 and carrier flanges 92 at each circumferential end 94a, 94b of the BOAS carrier 72. The carrier flanges 92 extend radially outwardly from the carrier body 90 and each include a flange opening 96, such as a slot or hole through which a first lever arm 88a extends. As illustrated in FIG. 3, the first lever arm 88a extends through flange openings 96 of two circumferentially adjacent BOAS carriers 72. In operation, rotation of the adjustment lever 76 about the lever axis 84 moves the BOAS carriers 72 radially inwardly and outwardly depending on the direction of the rotation, and thus likewise adjusts a radial position of the BOAS segments 70. Because each first lever arm 88a extends through flange openings 96 of two adjacent BOAS carriers 72, operation of each adjustment lever 76 actuates two circumferentially adjacent BOAS carriers 72.

The rotation of the adjustment lever 76 is driven and controlled by an electromechanical actuator 98 operably connected to the adjustment lever 76. In various embodiments, such as that illustrated in FIG. 3, the electromechanical actuator 98 is a high-force, short-stroke linear electromechanical actuator 98 positioned such that the actuator piston 100 contacts a second lever arm 88b of the adjustment lever 76. The force exerted on the second lever arm 88b by the actuator piston 100 drives rotation of the adjustment lever 76 about the lever axis 84, thus urging radial movement of, and controlling the position of the BOAS segments 70. The use of a lever increases the stroke length of the electromechanical actuator 98 versus the relative motion of the BOAS segments 70. This improves the position control of the BOAS segment 70 because the larger stroke of the actuator enables more precision in the measurement system within the electromechanical actuator 98 and reduces the size and weight of the electromechanical actuator 98 for a given BOAS segment 70 load. While a linear electromechanical actuator 98 arrangement is utilized in the embodiment of FIG. 3, one skilled in the art will readily appreciate that this is merely exemplary and that other types of actuators may be utilized in other embodiments.

Referring to FIG. 4, the aerodynamic design of turbines typically specifies the smallest possible axial spacing between adjacent rows of blades 64 and stator vane 104 to improve performance and reduce weight. Thus, the axial spacing between adjacent stator vane 104 components is also minimized and results in relatively minimal axial space for the BOAS segments 70, BOAS carriers 72, and adjustment lever 76.

Referring again to FIG. 4, the adjustment levers 76, the pin 78, and the BOAS carriers 72 are located axially in a common cavity 102 defined in the case member 74 between axially adjacent stator vane 104 components. More particularly, the common cavity 102 is defined in part by the casing flange 82 and an aft flange 120 located rearward of the casing flange 82. The adjustment lever 76 is located between the casing flange 82 and the aft flange 120, with the pin 78 extending through both the casing flange 82 and the aft flange 120 and the adjustment lever 76 to retain the adjustment lever 76. In various embodiments, a cover plate 122 is located axially upstream of the casing flange 82, covering the casing flange 82 and the pin 78 to improve isolation and sealing from the upstream pressure cavity 127 into the common cavity 102.

In various embodiments, a seal 200 is located in the common cavity 102 at, for example, an interface of the aft segment hooks 106 and a vane platform leg 129 of a vane 150, to improve isolation and sealing to the downstream pressure cavity 128. It should be understood that the total air pressure within upstream pressure cavity 127 is greater than flow path 126 and the common cavity 102. Additionally, the pressure within common cavity 102 is greater than the downstream pressure cavity 128. Leakage losses reduce performance of the engine 20, and the inclusion of elements such as the cover plate 122 and the seal 124 further improves sealing and prevents leakage from the higher pressure within the common cavity 102 into the relatively lower pressure flow path 126. This compact structure in which the adjustment mechanism components are located in the same common cavity 102 reduces potential leakage points and reduces the impact of the adjustment structure on the overall engine 20 configuration and minimizes the fluid leakage resulting from inclusion of the adjustment structure.

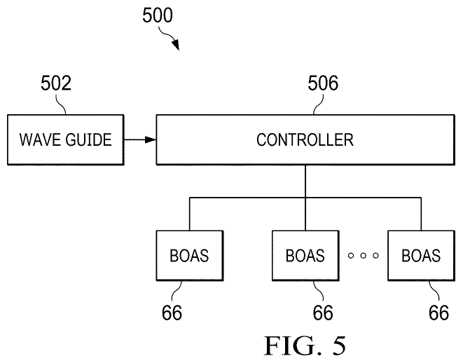

Referring now to FIG. 5, there is illustrated the manner in which a plurality of microwave sensors 500 may be paired with BOAS 504 to control their movement. The microwave sensors 500 comprise a plurality of microwave waveguides 502 that are interconnected with a controller 506. The plurality of waveguides 502 that are placed in various locations within the BOAS 504 there are also connected to the controller 506. The controller 506 will transmit a microwave signal that is propagated down the microwave waveguide 502 toward the blades of the turbine that are rotating within the BOAS 504. The microwave signal will reflect off the tips of the blades rotating pass the microwave waveguide 502 and be transmitted back to the controller 506. These reflections can be analyzed by the controller 506 and used to determine the clearance between the tips of the fan blades within the turbines and the BOAS 504. The total reflection is transmitted back to the controller 506 which may then measure the magnitude and phase characteristics of the electromagnetic wave that is reflected from the blade tip. This process utilizes a single frequency, continuous wave operation. The magnitude and phase of the reflected wave defines the position of the blade with respect to the aperture in the horn end 902. The magnitude and phase characteristics may then be converted into a distance between the aperture and the blade tip of the turbine.

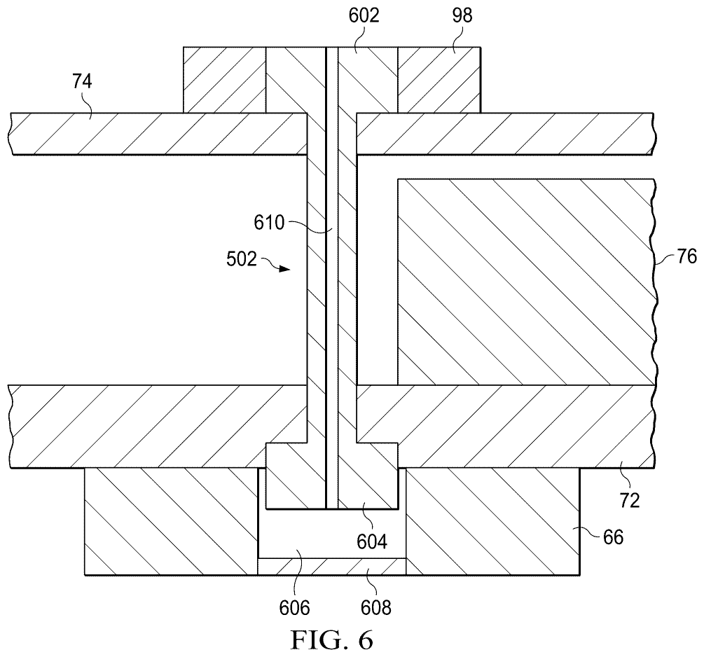

Referring now to FIG. 6, there is illustrated the microwave waveguide 502 installed with the BOAS 66. The BOAS 66 are moved between positions using the lever 76. The BOAS 66 are supported by a BOAS carrier 72 as described herein above. The carrier 72, lever 76 and BOAS 66 are mounted below the diffuser case member 74. The microwave waveguide 502 includes an upper cylindrical portion 602 that is configured to fit within and be secured to the electromechanical actuator 98. It will be appreciated that the upper cylindrical portion could be secured to any part of the engine. A lower cylindrical portion 604 is configured to be inserted within the BOAS 66. The upper cylindrical portion 602 is fixed to the electromechanical actuator 98. The lower cylindrical portion 604 slidably engages within a chamber 606 defined within the BOAS 66. Thus, the BOAS 66 may slide up and down with respect to the lower cylindrical portion 604 of the microwave waveguide 502 along a central axis of the microwave waveguide 502. The BOAS 66 also define an opening into which a quartz window 608 may be placed such that signals emitted from the microwave waveguide 502 may pass when reflecting off the blade tips of the turbines. Other types of materials may be utilized that are transparent to microwaves or other types of electromagnetic signals. The microwave waveguide 502 additionally defines a passageway 610 down the central axis of the microwave waveguide 502 to enable propagation of signals back and forth along the microwave waveguide.

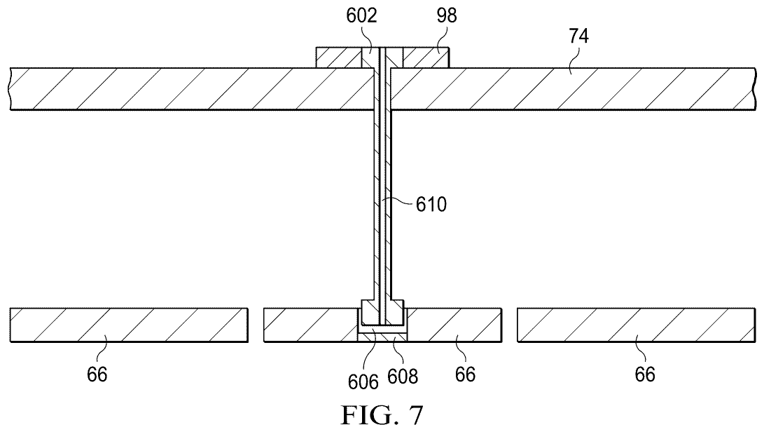

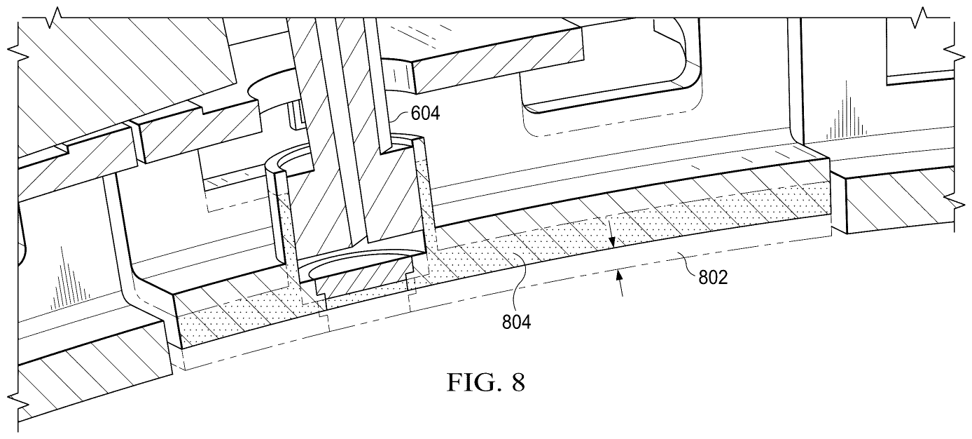

Referring now to FIGS. 7 and 8, there is more particularly illustrated the structure of a waveguide 502 mounted with respect to multiple BOAS 66 beneath the diffuser case member 74. Additionally, FIG. 8 illustrates the movement of the BOAS 66 with respect to the lower cylindrical portion 604 of the microwave waveguide 502. The BOAS 66 may move between a position illustrated at 802 when maximally extended toward the fan blades of the turbine to a position illustrated at 804 when the BOAS 66 are retracted fully. The controller 506 will know the position of the BOAS 66 based upon the provided control signals emitted from the waveguide 502 that reflect from the blade tip of the turbines will enable a determination of the clearance between the blade tips and the bottom surface of the BOAS 66.

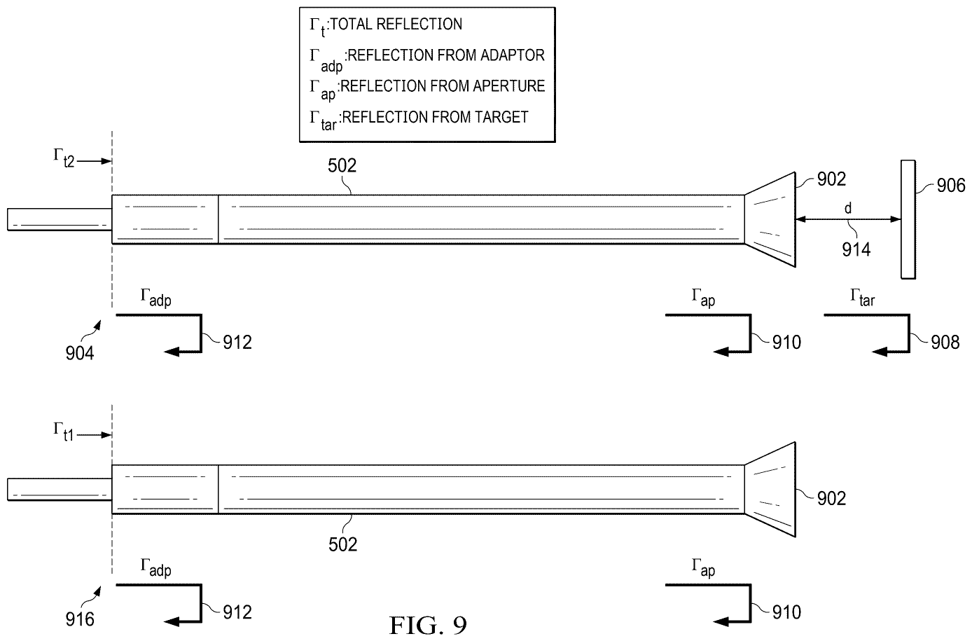

This operation is more particularly illustrated in FIG. 9. FIG. 9 illustrates two examples wherein the BOAS 66 are moved between positions using the lever 76. The BOAS 66 are supported by a BOAS carrier 72 as described herein above. The carrier 72, lever 76 and BOAS 66 are mounted below the diffuser case member 74. Microwave waveguide 502 is transmitting a signal down the length of the microwave waveguide to be emitted from the horn end 902 thereof. In the first instance shown at 904, the microwave signal transmitted from the horn end 902 will reflect from the target 906 as a reflection as target reflection 908. There will be similar signal reflections from the horn aperture and the adapter 912 through which the waveguide 502 is connected to the controller 506. In the case where the signal reflects from the target 906, the total reflection will consist of the target reflection 908, the aperture reflection 910 and the adapter reflection 912. This will enable a termination of the distance D 914 between the aperture of the horn end 902 and the target 906. Similarly, as shown at 916 when the signal does not reflect from the target 906 because no target is present at the opening of the waveguide 502, the total reflection will be represented by the aperture reflection 910 and the adapter reflection 912. This will enable a determination that no target 906 (i.e., the blade tip of a turbine) is present outside the waveguide 502 horn end 902.

Since the waveguide 502 includes no electronics or moving parts, the waveguide will not normally be integrated by normal operating conditions of the aircraft engine as would electronic components. The use of the waveguide 502 additionally enables the actual electronic components such as the controller 506 that makes the distance determination between the BOAS 66 and the tips of the turbine blades to be made at a location away from the waveguide 502 in a less operationally degrading operational location of the engine. This will enable continuous clearance control during the life of the engine with the prolonged deterioration seen by the waveguide 502.

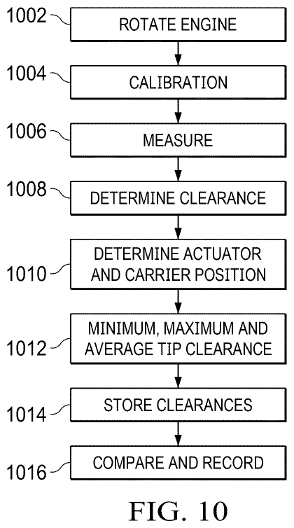

The microwave signals received from the microwave waveguide 502 may be used to control the operation of the BOAS 66. Control of the BOAS 66 would be provided by the controller 506. Various examples of modes of control for the BOAS 66 responses to the microwave signals received from the microwave waveguide 502 are illustrated herein below with respect to FIGS. 10-16. As mentioned previously, while the following descriptions relate to the control of BOAS 66 responsive to microwave signals, other signals of different wavelengths may be utilized for control in various types of aircraft engines.

Referring now to FIG. 10, there is illustrated the manner for controlling the BOAS 66 to enable cold calibration of the control system during construction of the gas turbine engine. The cold calibration process enables the determination of the clearance baseline between the turbine blades 64 and the BOAS 66 at engine build. During engine build, the engine is manually rotated at step 1002. Manual rotation enables MSW system calibration at step 1004. The position and length of the turbine blades 64 and the BOAS 66 are measured at step 1006 during the calibration process. The measurements are made for each of the turbine blades 64 and BOAS 66. This enables a determination at step 1008 of the clearance between the turbine blades 64 and the BOAS 66. The measurements are also used to determine at step 1010 the baseline actuator and carrier position with respect to the BOAS 66. Using this information the minimum tip clearance, maximum tip clearance and average tip clearance may be calculated between the turbine blades 64 and the BOAS 66 at step 1012. This provides the baseline clearance parameters which may be stored at step 1014. These baseline parameters may also be compared and recorded at step 1016 with respect to the digital twin of the system that has been modeled and historical clearances with respect to the gas turbine engine.

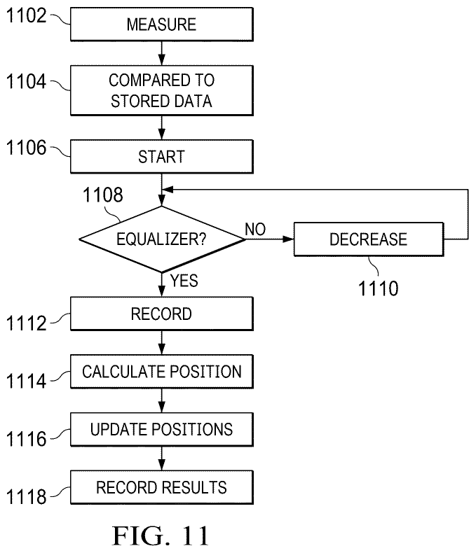

Referring now to FIG. 11, there is illustrated a flow chart for the green run break-in cycle or a post maintenance/inspection/overhaul event for the gas turbine engine. At a green run, the gas turbine engine operates throughout the speed range to record baseline clearances that are impacted by out of roundness and the effects of an initial rub. Each of the turbine blades 64 are measured individually at each waveguide sensing location at step 1102. This measured information is then compared at step 1104 to stored data generated previously in the cold calibration process. Initial gas turbine engine operation is started at step 1106. Inquiry step 1108 determines if each turbine blade tip is equalized to a threshold level where the blade tips will rub. If not, control passes to step 1110 and the BOAS 66 clearance with the turbine blades 64 is decreased. If the blade tips are equalized to a threshold level, the data and steps required to achieve the equalized position where the turbine blades 64 will rub is recorded at step 1112. A new baseline for the BOAS 66 position is then calculated at step 1114 that further includes a 0.006 inch offset. The baseline carrier 72 and actuator 98 positions are updated at step 1116 and these results may be recorded and stored at step 1118.

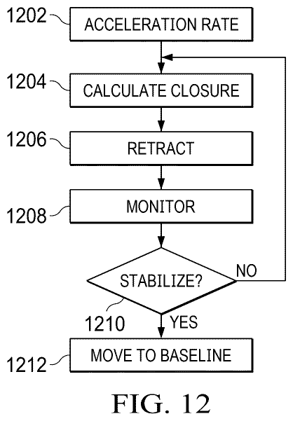

Referring now to FIG. 12, there is illustrated a flow chart of the control process for the BOAS 66 position when the gas turbine engine accelerates. The process determines at step 1202 a gas turbine engine acceleration rate based upon blade tips passing the microwave waveguides 502 at an increased rate. The determination may also be made based upon the monitoring of the engine control RPMs. The clearance closure rate between the BOAS 66 and blade tips caused by the acceleration is calculated at step 1204. This information is transmitted to the electromechanical actuators 98 to enable retraction at step 1206 of the BOAS 66. The clearance between the BOAS 66 and the turbine blade tips is monitored at step 1208 using the microwave waveguides 502 and inquiry step 1210 determines if the movement caused by engine acceleration has stabilized. If the stabilization has not occurred, control passes back to step 1204 to determine further closure. If inquiry step 1210 determines that movement caused by engine operation has stabilized, the BOAS 66 are moved to the new baseline position at step 1212.

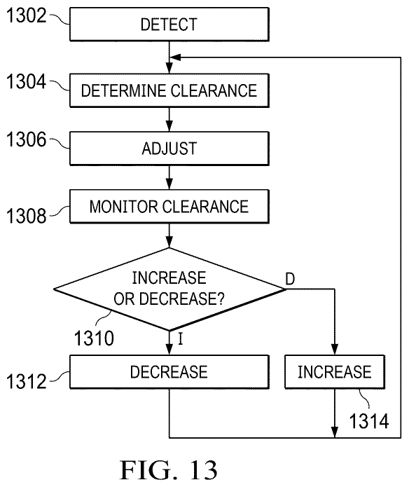

Referring now to FIG. 13, there is illustrated the process for controlling operation of the BOAS 66 responsive to a deceleration of the gas turbine engine. The gas turbine engine deceleration is detected at step 1302 and a desired clearance between the BOAS 66 and the tips of the turbine blades 64 is determined at step 1304. The BOAS 66 are adjusted at step 1306 to achieve the desired clearance between the BOAS and the turbine blade tips. The turbine blades 64 tip clearance with the BOAS 66 is monitored at step 1308 and inquiry step 1310 determines if the clearance is increasing or decreasing. If inquiry step 1310 determines that the clearance is decreasing, the BOAS 66 is adjusted at step 1314 to increase the decreasing clearance, and control passes back to step 1304. If inquiry step 1310 determines that the distance is increasing, the BOAS 66 is adjusted at step 1312 to decrease the distance before control passes back to step 1304.

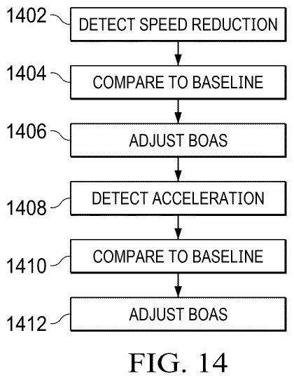

Referring now to FIG. 14, there is illustrated a flow diagram of the process for controlling the BOAS 66 responsive to a hot reburst condition of the gas turbine engine. A hot reburst condition occurs after the gas turbine engine is in a stabilized condition and the engine speed is then reduced. A speed reduction after engine stabilization is detected at step 1402. Responsive to the detected speed reduction, a comparison of the BOAS/blade tip clearance to the baseline model and/or a generated digital twin model is made at step 1404. The BOAS 66 are adjusted at step 1406 to achieve the desired baseline clearance. If acceleration of the engine is detected at step of 1408 to occur within a predetermined time period of the previously detected speed reduction, the clearances between the BOAS 66 and the turbine blades 64 are again compared at step 1410 to the baseline model/digital twin model and the BOAS 66 are adjusted at step 1412 to achieve the indicated clearance according to the models. The movement to achieve the indicated clearance avoids rubs between the turbine blade tips and the BOAS 66.

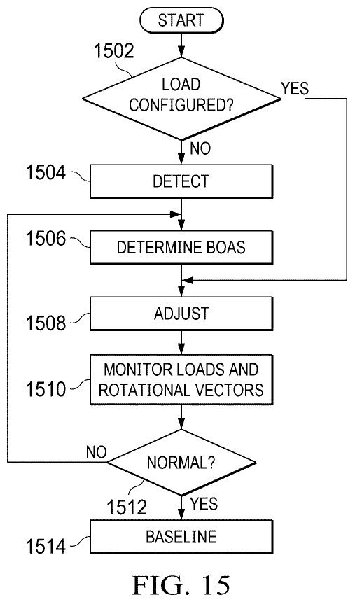

Referring now to FIG. 15, there is illustrated a flow diagram of the process for controlling positioning of the BOAS 66 responsive to high-speed maneuvering of the aircraft containing the gas turbine engine. Inquiry step 1502 initially determines if the aircraft is configured for known g-loads and angular rotation induced loads on the engine. If not, g-loads and angular rotation induced loads are detected on the engine at step 1504 and a determination is made at step 1506 of the impact of the g-loads and angular rotation induced loads on the BOAS 66. The clearance between the BOAS 66 and the turbine blades 64 is adjusted by adjusting at step 1508 the position of the BOAS. After this adjustment, the g-loads and angular rotation induced loads and rotational vectors are further monitored at step 1510, and inquiry step 1512 determines if g-loads and angular rotation induced loads on the gas turbine engine have returned to normal. If not, control passes back to step 1506 to determine the further impacts of the g-loads and angular rotation induced loads on the BOAS 66. When inquiry step 1512 determines that the g-loads and angular rotation induced loads have returned to normal, the BOAS 66 are returned at step 1514 to their baseline position. If the aircraft is determined at inquiry step 1502 to not be configured for known loads control passes directly to step 1508.

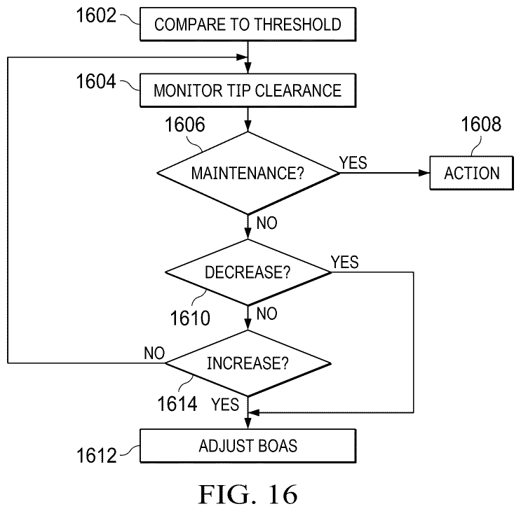

Referring now to FIG. 16, there is illustrated a flow diagram for controlling the BOAS 66 to account for turbine blades 64 position and health monitoring during engine operation for the turbine blades 64. The current clearance signals provided by the microwave waveguides are compared to stored threshold parameters and a digital twin model for the engine at step 1602 to enable continuous monitoring at step 1604 of the current blade tip clearance. Changes in the clearance would be caused by the long term deterioration factors such as oxidation, erosion or maintenance issues. Based upon the results of this monitoring, inquiry step 1606 determines if engine maintenance is required based upon the current blade tip clearance. If so, control passes to step 1608 to trigger an action to address the indicated maintenance problem. If inquiry step 1606 determines no maintenance is required, inquiry step 1610 determines if the blade tip clearance is decreasing. If so, the BOAS 66 are adjusted at step 612 to account for the decreased clearance. If inquiry step 1610 determines that there is no decrease in the clearance, inquiry step 1614 determines if there is a current increase in the BOAS 66 clearance with the turbine blades 64. If so, control passes again to step 1612 to adjust the BOAS 66 to overcome the indicated increase. If inquiry step 1614 determines that there is no increase, control returns to step 1604 to continue to monitor the clearance between the BOAS 66 and the turbine blades 64.

Although FIGS. 10-16 illustrates various examples of a processes for controlling positioning of BOAS 66 with respect to turbine fan blades, various changes may be made to FIGS. 10-16. For example, while shown as a series of steps, various steps in FIGS. 10-16 may overlap, occur in parallel, occur in a different order, or occur any number of times. Additionally, rather than controlling the BOAS 66 clearance with respect to turbine fan blades, clearances with other rotating portions of the gas turbine engine such as the compressors or fan may be controlled.

It may be advantageous to set forth definitions of certain words and phrases used throughout this patent document. The term “couple” and its derivatives refer to any direct or indirect communication between two or more components, whether those components are in physical contact with one another. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

1. A method for controlling clearance between a blade outer air seal (BOAS) and a rotating portion of a gas turbine engine, comprising:
detecting a current operating mode of the gas turbine engine;
determining a baseline clearance associated with the detected current operating mode of the gas turbine engine;
measuring a current clearance between the BOAS and the rotating portion of the gas turbine engine; and
adjusting a position of the BOAS to alter the current clearance from the measured current clearance to the baseline clearance associated with the detected current operating mode responsive to the measured current clearance.

2. The method of claim 1, further comprising:
establishing the baseline clearance between the BOAS and the rotating portion of the gas turbine engine during a cold calibration mode of the gas turbine engine during gas turbine engine manufacture;
calculating a minimum clearance, a maximum clearance and an average clearance between the BOAS and the rotating portion of the gas turbine engine during the cold calibration mode responsive to the established baseline clearance; and
storing the baseline clearance, the minimum clearance, the maximum clearance and the average clearance.

3. The method of claim 1, wherein adjusting the position of the BOAS further comprises:
determining if the rotating portion of the gas turbine engine is rubbing with the BOAS;
decreasing the current clearance between the BOAS and the rotating portion of the gas turbine engine responsive to a determination that the rotating portion of the gas turbine engine is not rubbing with the BOAS; and
storing the current clearance as the baseline clearance responsive to the determination that the rotating portion of the gas turbine engine is rubbing with the BOAS.

4. The method of claim 1, wherein adjusting the position of the BOAS further comprises:
detecting an acceleration of the gas turbine engine;
detecting a decrease in the measured current clearance between the BOAS and the rotating portion of the gas turbine engine responsive to the detected acceleration; and
retracting the BOAS to increase the current clearance responsive to the detected decrease of the measured current clearance.

5. The method of claim 4, wherein adjusting the position of the BOAS further comprises:
detecting a deceleration of the gas turbine engine;
detecting an increase in the measured current clearance between the BOAS and the rotating portion of the gas turbine engine responsive to the detected deceleration; and
moving the BOAS to decrease the current clearance responsive to the detected increase of the measured current clearance.

6. The method of claim 5, wherein adjusting the position of the BOAS further comprises:
determining a speed of the gas turbine engine has stabilized; and
moving the BOAS to the baseline clearance responsive to the determination that the speed of the gas turbine engine has stabilized.

7. The method of claim 1, wherein adjusting the position of the BOAS further comprises:
determining occurrence of a hot reburst condition within the gas turbine engine; and
moving the BOAS to alter the current clearance responsive to detection of the hot reburst condition.

8. The method of claim 1, wherein adjusting the position of the BOAS further comprises:
detecting g-loads and angular rotation induced loads acting upon the gas turbine engine;
determining the BOAS effected by the detected g-loads and angular rotation induced loads; and
adjusting the position of the BOAS effected by the detected g-loads and angular rotation induced loads to counteract the detected g-loads and angular rotation induced loads.

9. The method of claim 1, wherein adjusting the position of the BOAS further comprises:
determining a change in the measured current clearance caused by long term deterioration factors; and
adjusting the position of the BOAS to overcome the long term deterioration factors responsive to the determined change.

10. A system for controlling clearance within a gas turbine engine:
a rotating portion of the gas turbine engine;
a blade outer air seal (BOAS) configured to move between a plurality of positions with respect to the rotating portion of the gas turbine engine;
a controller configured to control movement of the BOAS between the plurality of positions with respect to the rotating portion of the gas turbine engine, wherein the controller is further configured to:
detect a current operating mode of the gas turbine engine;
determine a baseline clearance associated with the detected current operating mode of the gas turbine engine;
measure a current clearance between the BOAS and the rotating portion of the gas turbine engine; and
adjust a position of the BOAS to alter the current clearance from the measured current clearance to the baseline clearance associated with the detected current operating mode responsive to the measured current clearance.

11. The system of claim 10, wherein the controller is further configured to:
establish the baseline clearance between the BOAS and the rotating portion of the gas turbine engine during a cold calibration mode of the gas turbine engine during gas turbine engine manufacture;
calculate a minimum clearance, a maximum clearance and an average clearance between the BOAS and the rotating portion of the gas turbine engine during the cold calibration mode responsive to the established baseline clearance; and
store the baseline clearance, the minimum clearance, the maximum clearance and the average clearance.

12. The system of claim 10, wherein the controller is further configured to:
determine if the rotating portion of the gas turbine engine is rubbing with the BOAS;
decrease the current clearance between the BOAS and the rotating portion of the gas turbine engine responsive to a determination that the rotating portion of the gas turbine engine is not rubbing with the BOAS; and
store the current clearance as the baseline clearance responsive to the determination that the rotating portion of the gas turbine engine is rubbing with the BOAS.

13. The system of claim 10, wherein the controller is further configured to:
detect an acceleration of the gas turbine engine;
detect a decrease in the measured current clearance between the BOAS and the rotating portion of the gas turbine engine responsive to the detected acceleration; and
retract the BOAS to increase the current clearance responsive to the detected decrease of the measured current clearance.

14. The system of claim 13, wherein the controller is further configured to:
detect a deceleration of the gas turbine engine;
detect an increase in the measured current clearance between the BOAS and the rotating portion of the gas turbine engine responsive to the detected deceleration; and
move the BOAS to decrease the current clearance responsive to the detected increase of the measured current clearance.

15. The system of claim 14, wherein the controller is further configured to:
determine a speed of the gas turbine engine has stabilized; and
move the BOAS to the baseline clearance responsive to the determination that the speed of the gas turbine engine has stabilized.

16. The system of claim 10, wherein the controller is further configured to:
determine occurrence of a hot reburst condition within the gas turbine engine; and
move the BOAS to alter the current clearance responsive to detection of the hot reburst condition.

17. The system of claim 10, wherein the controller is further configured to:
detect g-loads and angular rotation induced loads acting upon the gas turbine engine;
determine the BOAS effected by the detected g-loads and angular rotation induced loads; and
adjust the position of the BOAS effected by the detected g-loads and angular rotation induced loads to counteract the detected g-loads and angular rotation induced loads.

18. The system of claim 10, wherein the controller is further configured to:
determine a change in the current clearance caused by long term deterioration factors; and
adjust the position of the BOAS to overcome the long term deterioration factors.

19. A method for controlling clearance between a blade outer air seal (BOAS) and a rotating portion of a gas turbine engine, comprising:
detecting a current operating mode of the gas turbine engine, wherein current the operating mode comprises one of an acceleration mode, a deceleration mode, a hot reburst mode, a high-g maneuver mode;
determining a baseline clearance associated with the detected current operating mode of the gas turbine engine;
measuring a current clearance between the BOAS and the rotating portion of the gas turbine engine responsive to the detected operating mode of the gas turbine engine; and
adjusting a position of the BOAS to maintain the measured current clearance at a predetermined level associated with the detected current operating mode responsive to the measured current clearance.

20. The method of claim 19 further comprising establishing the predetermined level associated with the detected operating mode during calibration of the gas turbine engine.
